(19) United States
(12) Patent Application Publication
(10) Pub. No.: US 2026/0187878 A1
(43) Pub. Date: Jul. 2, 2026

(54) IMAGE GENERATION METHOD AND APPARATUS, ELECTRONIC DEVICE AND STORAGE MEDIUM

(71) Applicant: Beijing Zitiao Network Technology, Co., Ltd., Beijing (CN)

(72) Inventors: Mengtian LI, Beijing (CN); Songtao ZHAO, Beijing (CN); Zhuowei CHEN, Beijing (CN); Peng ZHANG, Beijing (CN); Jinshu CHEN, Beijing (CN); Qichao SUN, Beijing (CN)

(21) Appl. No.: 19/425,845

(22) Filed: Dec. 18, 2025

(30) Foreign Application Priority Data
Dec. 27, 2024 (CN) 202411959509.9

(51) Int. Cl. G06T 11/60; G06V 10/77

(52) U.S. Cl. CPC G06T 11/60; G06V 10/7715

(57) ABSTRACT

An image generation method and apparatus, a computer device and a storage medium are provided. The method includes: acquiring an initial text and an initial image, where the initial image includes at least one subject, and the at least one subject corresponds to at least one subject feature; generating a first intermediate image according to the initial text; performing feature extraction on the at least one subject feature, and performing subject redrawing at least once based on extracted information, to generate a second intermediate image; and fusing the first intermediate image and the second intermediate image to generate a target image.

### CROSS-REFERENCE TO RELATED APPLICATION

The present application claims priority to Chinese Patent Application No. 202411959509.9, filed on Dec. 27, 2024, which is incorporated herein by reference in its entirety as a part of the present application.

### TECHNICAL FIELD

The present disclosure relates to the technical field of computers, in particular to an image generation method and apparatus, a computer device and a storage medium.

### BACKGROUND

Image generation refers to the generation of new images through computer algorithms and models. With the popularization and development of computer technology, users'requirements for image generation are also becoming increasingly specific and diversified.

The generation styles provided by the currently available image generation functions are relatively monotonous. All adjustments made are minor modifications to the overall shape or structure of the original image, and the style of the generated image is strongly correlated with that of the original one. It is difficult to generate images with significant style changes, which impairs the user experience.

### SUMMARY

In view of this, embodiments of the present disclosure provide an image generation method and apparatus, a computer device and a storage medium to solve or partially solve the above problems.

Based on the above objective, in a first aspect of the present disclosure, there is provided an image generation method, including:

acquiring an initial text and an initial image, where the initial image includes at least one subject, and the at least one subject corresponds to at least one subject feature;

generating a first intermediate image according to the initial text;

performing feature extraction on the at least one subject feature, and performing subject redrawing at least once based on extracted information, to generate a second intermediate image; and

fusing the first intermediate image and the second intermediate image to generate a target image.

In a second aspect of the present disclosure, there is provide an image generating apparatus, including:

a first module, configured to acquire an initial text and an initial image, where the initial image includes at least one subject, and the at least one subject corresponds to at least one subject feature;

a second module, configured to generate a first intermediate image according to the initial text;

a third module, configured to perform feature extraction on the at least one subject feature, and perform subject redrawing at least once based on extracted information, to generate a second intermediate image; and

a fourth module, configured to fuse the first intermediate image and the second intermediate image to generate a target image.

In a third aspect of the present disclosure, there is provided a computer device, including a memory and at least one processor, where the memory is configured to store a computer program executable on the at least one processor, and the computer program, upon executed by the at least one processor, causes the at least one processor to implement the method as described in the first aspect.

In a fourth aspect of the present disclosure, there is provided a non-transient computer-readable storage medium comprising computer instructions stored therein, where the computer instructions, upon executed by a computer, cause the computer to implement the method as described in the first aspect.

### BRIEF DESCRIPTION OF DRAWINGS

In order to more clearly explain the technical solutions in the embodiments of the present disclosure or related technology, the drawings that need to be used in the description of the embodiments or related technology will be briefly introduced below. Obviously, the drawings in the following description are only embodiments of the present disclosure, and other drawings can be obtained by those ordinary skilled in the art without creative labor.

FIG. 1 shows a schematic diagram of an exemplary system 100 according to an embodiment of the present disclosure.

FIG. 2 shows a schematic diagram of effect comparison between an input image and an output image according to an exemplary method of an embodiment of the present disclosure.

FIG. 3 shows a flowchart of an exemplary method 300 provided by an embodiment of the present disclosure.

FIG. 4 shows a flowchart of an exemplary method 300 in a specific scenario provided by an embodiment of the present disclosure.

FIG. 5 shows a schematic diagram of an exemplary apparatus 500 provided by an embodiment of the present disclosure.

FIG. 6 shows a schematic diagram of an exemplary computer device 600 provided by an embodiment of the present disclosure.

### DETAILED DESCRIPTION

In order to make the purpose, technical solutions and advantages of the description clearer, the description will be further explained in details in combination with specific embodiments and with reference to the accompanying drawings.

It should be noted that, unless otherwise defined, technical terms or scientific terms used in the embodiments of the present disclosure should have their ordinary meanings as understood by those of ordinary skills in the art to which the present disclosure belongs. The words “first”, “second” and similar words used in the embodiments of the present disclosure do not indicate any order, quantity or importance, but are only used to distinguish different components. Similar words such as “comprising/including” or “containing” mean that the elements or objects appearing before the word cover the elements or objects listed after the word and their equivalents, without excluding other elements or objects. Similar words such as “connection/connecting” or “connected” are not limited to physical or mechanical connection, but can include electrical connection, whether direct or indirect. “Up/upper”, “down/lower”, “left” and “right” are only used to indicate the relative positional relationship. When the absolute position of the described object changes, the relative positional relationship may also change accordingly.

It may be understood that before using the technical solutions disclosed in the embodiments of the present disclosure, the user shall be informed of the type, range of use, use scenarios, etc., of personal information involved in the present disclosure and the authorization of the user shall be obtained through appropriate means in accordance with relevant laws and regulations.

For example, in response to receiving an active request from a user, prompt information is sent to the user to clearly prompt the user that the requested operation will require access to and use of the user's personal information. In this way, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. In addition, the pop-up window may also include a selection control for the user to select “agree” or “disagree” to provide the personal information to the electronic device.

It may be understood that the above process of notifying and obtaining user authorization is only illustrative and does not limit the implementations of the present disclosure, and other methods that satisfy relevant laws and regulations may also be applied to the implementations of the present disclosure.

It can be understood that the data (including but not limited to the data itself, data acquisition or use) involved in this technical solution shall comply with the requirements of corresponding laws, regulations and relevant provisions.

In order to make the purpose, technical solutions and advantages of the description clearer, the description will be further explained in details in combination with specific embodiments and with reference to the accompanying drawings.

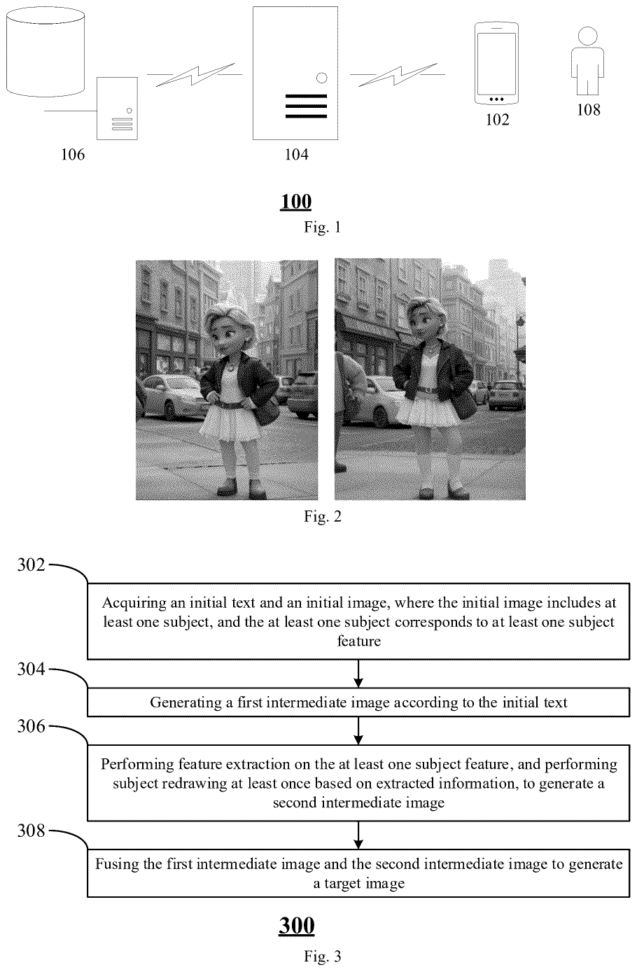

FIG. 1 shows a schematic diagram of an exemplary system 100 according to an embodiment of the present disclosure. The system 100 may be a system for realizing image generation.

As shown in FIG. 1, in a case where a terminal device and a server jointly perform object display method, by way of example, the system 100 may include a terminal device 102, a server 104, and a database server 106. The terminal device 102 and the server 104 are connected through a network, for example, through a wired or wireless network connection. Alternatively, the means for realizing image generation may be integrated in the terminal device 102. The database server 106 and the server 104 are connected through a network, for example, through a wired or wireless network connection. The database server 106 may store various data related to the execution of the image generation method, such as the basic images, image parameters, generation algorithms, and the like.

The terminal device 102 can be installed with various applications (APP for short), such as image processing applications, video conferencing applications, life service applications, reading applications, video applications, social applications, payment applications, web browsers, instant messaging tools, etc. These applications can all be used for image generation and/or display of generated images. As an alternative example, an application program (APP) installed on the terminal device 102 may be downloaded and installed from the server 104.

The terminal device 102 here can be hardware or software. When the terminal device 102 is hardware, it can be various electronic devices with display screens, including but not limited to smart phones, tablet computers, e-book readers, MP3 players, Laptop computers, desktop computers (PC) and the like. When the terminal device 102 is software, it can be installed in the electronic devices listed above. It can be implemented as multiple pieces of software or multiple software modules (for example, to provide distributed services) or implemented as a single piece of software or a single software module. It is not specifically limited here.

The server 104 may be a server that provides various services. For example, a backend server that provides support for various applications displayed on the terminal device 102. The database server 106 may also be a database server that provides various services. It can be understood that the database server 106 may not be provided in the system 100 when the server 104 can realize the related functions of the database server 106.

Here, the server 104 and the database server 106 can also be hardware or software. In the case of hardware, they can be implemented as a distributed server cluster composed of multiple servers or implemented as a single server. In the case of software, they can be implemented as multiple pieces of software or multiple software modules (for example, to provide distributed services) or implemented as a single piece of software or a single software module. It is not specifically limited here.

It should be noted that the image generation method provided by the embodiment of the present disclosure can be executed by the system 100. Specifically, it can be executed interactively among the terminal device 102, the server 104 and the database server 106. It can be understood that when the terminal device 102 is provided with the functions required by the server 104 and the database server 106 to execute the image generation method, the terminal device 102 can also perform the functions independently. It should be understood that the numbers of terminal devices 102, servers 104, database servers 106 and users 108 in FIG. 1 are only schematic. According to actual needs, there can be any number of terminal devices, users, servers and database servers.

In an exemplary application scenario, a user 108 can input an instruction to make an image through the terminal device 102, and the server 104 can provide an image generation service to the user 108 based on the instruction, and display an operation interface of the image generation service in a page through the terminal device 102.

As mentioned in the background section, in some examples, users can use AI (Artificial Intelligence) to generate images, for example, using AIGC (Artificial Intelligence Generated Content). Image generation refers to the generation of new images through computer algorithms and models.

In some examples, the image generation tool can be software or program with image generation function. However, it is not specifically limited here. Specifically, a tool that has image generation ability and completes intelligent image generation through interaction with operators can be considered as an image generation tool.

In a more specific scenario, the user 108 can use an image processing application (APP) to generate images with the aid of AIGC. As shown in FIG. 2, in an example, a user can input the image at the left side of FIG. 2, as the original image, into an image processing application, and after the corresponding settings are completed, the image processing application will use a corresponding image generation model to generate an image. The image generation model here is mainly a basic large model for image generation, and its model structure can be stacked GAN, Diffusion Models, Unet, etc. After that, in order to generate images with specific styles on the basis of the basic large model, it is necessary to provide specific constraints for the basic large model, so that some plug-ins (which can be understood as small models providing constraints) can be set on the basic large model, and the required constraints can be provided for the basic large model through these plug-ins, so as to finally form images with different styles, as shown in the effect diagram at the right side of FIG. 2. Among them, according to different specific scenarios, there are many kinds of plug-ins for the basic large model. However, in this example, as can be seen from the images at the left and right sides in FIG. 2, the style changes of these two images tend to be single and monotonous, or the generated image at the right side has a strong correlation with the original image at the left side. Even if the user inputs different keywords or prompts during image generation, the degree of change is within a certain range, which fails to provide users with a realistic feel like portrait photography (subject) and also fails to realize stylized image effects (background, etc.). In particular, users cannot independently set a stylized portrait photography effect. That is to say, in this example, the generated images can only be adjusted to a certain extent based on the provided initial images, with relatively monotonous or convergent changes. The overall composition is quite similar to that of the initial images and has a strong correlation, making it difficult to generate images with significant style changes, which seriously impairs the user experience.

In combination with the above-mentioned actual situation, the embodiment of the present disclosure provides an image generation method. In the process of image generation, an image generated by using an initial text and an image generated according to an initial image are processed separately, so as to reduce the correlation therebetween and realize the decoupling therebetween. In this way, a background image or an image structure whose style is more consistent with the content of the initial text can be generated firstly based on the initial text, and then multiple redraws of the main subject can be performed with the initial image as the primary reference. Finally, the two images are fused together to complete the image generation. In the whole process, the initial text and the initial image utilize relatively less information from each other during image generation, so that the generated background and main subject can satisfy the requirements of users respectively, and finally a personalized image conforming with the demands of users better is generated. As a result, the requirements of users for personalized image style setting are satisfied, and the users' experiences are significantly improved.

FIG. 3 shows a flowchart of an exemplary method 300 provided according to an embodiment of the present disclosure. Optionally, the method 300 can be used to generate images, especially images with great style changes. The method 300 can be implemented by the terminal device 102 of FIG. 1 or by the system 100 of FIG. 1.

As shown in FIG. 3, the image generation method exemplarily provided by the embodiment of the present disclosure may specifically include the following steps.

Step 302, acquiring an initial text and an initial image, where the initial image includes at least one subject, and the at least one subject corresponds to at least one subject feature.

In this step, both the initial text and the initial image are initial data for image generation. The text or image can be provided by the user through a corresponding port when using an image generation tool, or can be imported in batches through tables or links. In some examples, the user 108 can upload the initial text or initial image to the image generation tool of the server 104 by using the terminal device 102, or the user 108 can acquire the initial text or initial image from corresponding channels by operating the image generation tool of the server 104 on the terminal device 102. Of course, in some other examples, the user 108 can also use the terminal device 102 to acquire the corresponding initial text or initial image from the server 104. This is not specifically limited in the present example.

After that, for the initial image, it needs to contain at least one subject, which can generally be a person or an animal or plant; and in certain cases, it can also be an article, for example, a house in the wilderness can be regarded as a subject. After that, the specific subject can be confirmed by the user's designation, or it can be automatically recognized by settings. For example, in the process of image generation for selfie, the human body or face can be automatically recognized as the subject. Further, the subject must contain all kinds of related features. For example, if the human face is the subject, the shape, size and position of the facial organs, the skin color and the like of the human face can be taken as the corresponding features of the subject, that is, the subject features. The specific forms or types of subject features are not specifically limited here. As long as the subject can be restored based on certain features, these features can be considered as subject features.

For example, the user 108 can arbitrarily provide one or more images containing the same user's face as an initial image, such as a selfie of the same user's face from different angles, where the face is the subject and the relevant feature information corresponding to the face is the subject feature. After that, an initial text containing multiple keywords or prompts is provided, for example, a specific description “In the snowy spruce forest, wearing a black coat, earmuffs and a blue scarf, on a sunny day, the wind blows the hair and the hair is fluffy”. In this example and the following examples, exemplary description will be given with reference to the case where an initial image including a facial image is acquired.

Step 304: generating a first intermediate image according to the initial text.

In this step, after the initial text is acquired, the image generation can be carried out according to the initial text. Here, the corresponding image generation can be completed with the aid of a text-to-image model. The input of the model is the initial text, and the output is the image containing content corresponding to most of or all of the prompt words in the initial text, which is the first intermediate image.

In some examples, it's desired to realize the fusion of the first intermediate image and a second intermediate image generated later according to the initial image in a better way, and avoid excessive senses of tearing or incongruity of the images after the fusion, for example, the human body movements or facial expressions and the like presented in the second intermediate image may be excessively inconsistent with the scene presented in the first intermediate image. To this end, in the process of generating the first intermediate image, some constraints can be provided by using relevant information such as the subject features in the initial image. For example, the initial image is a selfie image, and its subject is a human face or a human body. According to these subject features, a position where a human body or face can be easily fused may be reserved in the generated first intermediate image; alternatively, a human body or face may be included in the first intermediate image, in which case fusion can be completed simply by replacing it with the second intermediate image. That is to say, when generating the first intermediate image, relevant plug-ins can be used to acquire relevant feature information of the subject features, and then the feature information can be used as constraints to restrict the image generation process, so as to form the first intermediate image. That is, in some examples, the step of generating a first intermediate image according to the initial text includes: determining feature information of the at least one subject feature; and using the feature information as a restriction during generating the first intermediate image.

In a more specific scenario, feature information can be determined by using a feature-preserving plug-in, and then the feature information is embedded, by using the feature-preserving plug-in, into a model for generating the first intermediate image. Specifically, the model for generating the first intermediate image can be any text-to-image model, and the feature-preserving plug-in can be an ID-preserving plug-in.

Step 306, performing feature extraction on the at least one subject feature, and performing subject redrawing at least once based on extracted information, to generate a second intermediate image.

In this step, the subject is re-drawn to form a second intermediate image. Firstly, it is necessary to perform information extraction on the subject features to get the extracted information. Here, corresponding fine-tuning models or feature extraction models can be used to extract and collect specific feature information. That is, in some examples, a feature extraction model can be used to extract at least one subject feature and redraw the subject at least once. Then the fine-tuning model is used to redraw the subject at least once, which can be local beautification of the subject, coordination with the first intermediate image, defect treatment and so on. Finally, a second intermediate image to be fused with the first intermediate image is generated.

In the specific generation process, feature information can be extracted from the subject features in the initial image, and then redrawing based on the extracted information can be carried out by using preset templates or models. The redrawing may be, for example, direct beautification processing, whitening processing, defect removal processing. Alternatively, some basic information of the first intermediate image, such as texture, light and shadow, etc., can be directly acquired, and then redrawing can be carried out based on the information. Of course, in the process of redrawing, it is also possible to perform some fine adjustments such as facial organ deformation and skin tone homogenization. Thus, after one or more times of redrawing, a second intermediate image is formed.

In some examples where part of information of the initial image has been used for reference when generating the first intermediate image, the generated first intermediate image may already have a position for fusion with the second intermediate image. For example, the first intermediate image itself contains a person with corresponding facial features, and the initial image may be at least one facial image of the same person, and then the generated second intermediate image can be directly used to perform face replacement in the first intermediate image to complete the fusion. Furthermore, in order to carry out the fusion more conveniently, and to improve the degree of fusion between the subject and the background, the subject in the first intermediate image can be recognized first, and this recognition process can be carried out differently depending on the types of the subjects. For example, the subject is a face, and then the face can be recognized in the first intermediate image, and the face can be cropped. The cropped image can be regarded as a third intermediate image, where the third intermediate image is a facial image obtained by cropping. That is, in some examples, before the step of performing subject redrawing at least once based on the extracted information, the method further includes: performing subject recognition on the first intermediate image; and performing image cropping based on a recognition result to generate a third intermediate image.

In some examples, after the third intermediate image is generated, it can be used as a reference to redraw the subject by means of feature migration. For example, in an example where the human face is the subject, the feature extraction model can be used to map the facial shape, the facial organs, the age and other information contained in the extracted information onto the third intermediate image, so as to transfer the features and complete a redrawing of the subject once. That is, in some examples, the step of performing subject redrawing at least once based on the extracted information includes: performing, based on the third intermediate image, feature migration according to the extracted information, and performing subject redrawing at a subject position in the third intermediate image according to the extracted information.

Furthermore, in the process of feature migration, in order to prevent the shape and angle of the subject from changing beyond expectations, a corresponding posture model can be used for control. In some examples, information such as the current posture of the subject can be extracted by means of the posture model, to acquire corresponding posture features. For example, when a human face is the subject, posture information such as the angle, size and orientation of the human face can be extracted; alternatively, when a human body or an animal or plant is the subject, the current action posture and the body shape information of the subject can be extracted. After that, the subject's posture in the process of feature migration is controlled according to these posture features, to prevent from problems such as a distortion caused by excessive deformation of the subject. That is, in some examples, the step of performing feature migration according to the extracted information includes: extracting posture features from the subject postures by using a posture model, where the subject postures are controlled based on the posture features during the feature migration.

In some examples, in order to further improve the degree of fusion between the generated second intermediate image and the generated first intermediate image, and to prevent from large difference after fusion, it's possible to acquire some information of the first intermediate image, such as texture information, light and shadow information firstly, and then perform redrawing once on the basis of the extracted information, or it's possible to perform redrawing on the basis of the previous redrawing. The texture information here refers to the texture, roughness and other characteristics of the object surface shown in the image; and the light and shadow information refers to the light and shade effect produced by light shining on the object, including the contrast between light and shadow. That is, in some examples, the step of performing subject redrawing at least once based on the extracted information includes: determining the texture information and light and shadow information of the first intermediate image; and redrawing, based on the extracted information, the at least one subject according to the texture information and the light and shadow information. Of course, reference can also be made to some other image attributes for the current redrawing, such as contrast information, tone information and other basic attributes of images.

In some examples, after redrawing according to the image attributes of the first intermediate image, the subject features obtained by redrawing may cause problems such as inconsistent resolution, changes in local features, changes in overall color and even color unevenness. In view of this, after the redrawing, a post-processing adjustment can be made to locally fine-tune the redrawn image. The problem of inconsistent resolution can be solved by adjusting the resolution through image super-resolution; local deformation can be used to adjust the changes in local specific features, such as the adjustment of facial organs of human face or animal face, and the adjustment of human body or animal and plant limbs; methods such as color homogenization (for example, averaging the overall skin color or adjusting the skin color based on the color that occupies most of the area, etc.) to uniformly adjust the overall color of the subject. That is, in some examples, after redrawing the at least one subject, the method further includes: adjusting a resolution of the redrawn subject feature, adjusting a deformation of local specific feature and/or uniformly adjusting an overall color feature, so as to locally fine-tune the redrawn subject feature.

Furthermore, for images adjusted through post-processing, since local fine-tuning has been performed, new defects may emerge, and the definition may also change or fail to meet the required standards. Therefore, targeted adjustments can be made again, followed by a redrawing. For example, defects can be identified based on the rules of color changes. For the determined positions of defects, repairs can be carried out according to the basic image information such as colors and patterns of the normal areas around the defects. Similarly, if it is determined that the definition of the current image does not meet the requirements, definition enhancement adjustments can be made. Specifically, definition adjustments can be performed by means of resolution adjustment, color correction, noise removal, and the like. That is, in some examples, the step of performing subject redrawing at least once based on extracted information includes: performing defect inspection and/or definition determination on the subject feature after local fine-tuning adjustment; in response to a presence of defect in the subject feature after local fine-tuning and/or a requirement of definition adjustment, performing defect adjustment on the defect position according to the image information around the defect position, and/or adjusting the definition according to a set definition, so as to perform the subject redrawing at least once again.

Step 308: fusing the first intermediate image and the second intermediate image to generate a target image.

In this step, after the first intermediate image and the second intermediate image are generated, they can be fused in a predetermined way, for example, by arranging the subject of the second intermediate image at a set position of the first intermediate image, or by replacing the subject in the first intermediate image according to the foregoing examples, etc. Finally, the fused image is the target image (also referred to as resulted image).

Finally, the generated target image can be displayed and output on a corresponding device to provide an operator with corresponding feedback. Of course, in some other examples, the output mode of the target image is not limited to outputting for display. The target image can also be used for storage, presentation, usage or reprocessing. According to different application scenarios and implementation needs, the specific output mode of the target image can be flexibly selected.

For example, for an application scenario where the method of this example is executed on a single device, the target image can be directly output on a display component (monitor, projector, etc.) of the current device for displaying, so that the operator of the current device can directly view the content of the target image through the display component.

In another example, for an application scenario where the method of this example is executed on a system composed of multiple devices, the target image can be sent to other preset devices, as receivers, in the system, that is, the synchronous terminals, through any data communication mode (wired connection, NFC, Bluetooth, Wi-Fi, cellular mobile network, etc.), so that the synchronous terminals can carry out subsequent processing. Optionally, the synchronization terminal can be a preset server, and the server is generally set in the cloud and used as a data processing and storage center, which can store and delivery the target image. Among them, receiving ends of the delivery are terminal devices, and the holders or operators of these terminal devices can be operators (users) of image generation operations, maintenance personnel of image generation tools, image supervisors and so on.

In yet another example, for an application scenario where the method of this example is implemented on a system composed of a plurality of devices, the target image can be directly sent to a preset terminal device through any data communication mode, and the terminal device can be one or more of those listed in the aforementioned paragraphs.

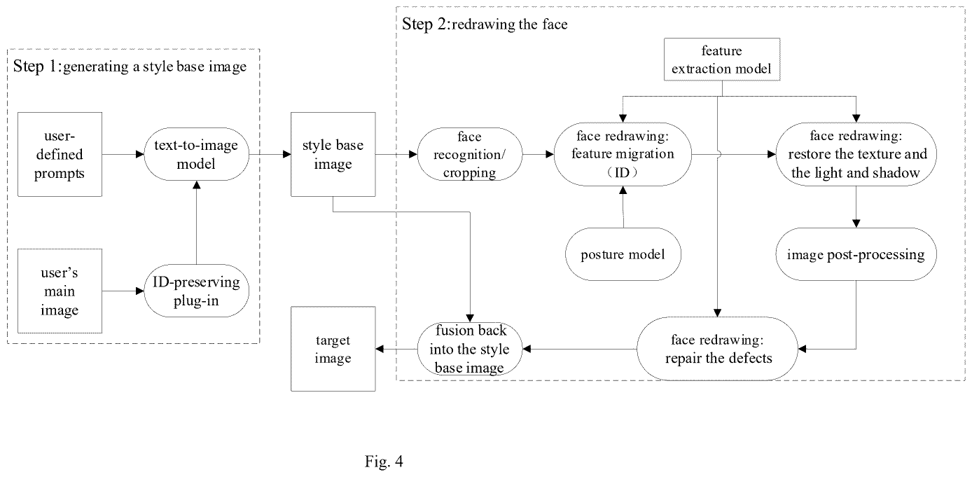

In a specific application scenario, image generation for portrait photography is taken as an example, in which the subject mainly corresponds to the facial image. As shown in FIG. 4, the image generation method mainly includes two key steps, namely, generating the first intermediate image and generating the second intermediate image, which correspond to generating a style base image and redrawing the face, respectively, in this example. In this technical solution, style generation and face generation are not coupled in a single text-to-image process, but are explicitly decoupled. This processing method allows different models to be used in two stages. For example, a basic model with larger number of parameters is used in style generation, so as to better follow the user's prompts to generate high-quality images; while a more lightweight and highly customized model is used in face generation.

For the input of this embodiment, it mainly includes user-defined prompts, i.e., user's descriptors about the desired styles, which may include information such as characters, costumes, actions, composition and scenes; user's main image, i.e., the image with the most frontal face orientation, the least face occlusion and higher definition among the images uploaded by the user; user feature extraction model, i.e., a customized model representing user's ID information, which is trained based on the feature extraction model by using images uploaded by the user (user's main image). After that, for the specific key process, it mainly includes the following steps. Step 1, text-to-image stage. First of all, in addition to a text-to-image basic model, a matching ID-preserving plug-in is needed to improve the ID similarity of generated images. User-defined prompts and user's main image are respectively input into the text-to-image basic model and the ID-preserving plug-in, and then the ID-preserving plug-in embeds the extracted ID information into the text-to-image model to generate a style base image with user ID. Step 2: face redrawing stage. Firstly, a face part in the style base image is recognized and cropped, and then the face part is redrawn three times by using a user feature extraction model. The first redrawing is used to migrate the user's ID information, that is, the facial shape, the facial organs, the age and other information contained in the user feature extraction model are mapped onto the face base image; and meanwhile a posture model is used to ensure that the face angle will not change dramatically after redrawing. The second redrawing is used to restore the texture and the light and shadow of the style base image, that is, to extract reference information from the style base image to guide the redrawing process. Next, several image post-processing methods are used to fine-tune the redrawn results, such as super-resolution, facial organ deformation, skin homogenization and so on. The third redrawing is used to repair the defects introduced by post-processing and improve the definition. Finally, the redrawn facial image is fused back into the style base image.

As can be seen from the above embodiments, in the image generation method provided by the embodiment of the present disclosure, the image generated by using the initial text and the image generated according to the initial image are processed separately, so as to reduce the correlation therebetween and realize the decoupling therebetween. In this way, a background image or an image structure whose style is more consistent with the content of the initial text can be generated firstly based on the initial text, and then multiple redraws of the main subject can be performed with the initial image as the primary reference. Finally, the two images are fused together to complete the image generation. In the whole process, the initial text and the initial image utilize relatively less information from each other during image generation, so that the generated background and main subject can satisfy the requirements of users respectively, and finally a personalized image conforming with the demands of users better is generated. As a result, the requirements of users for personalized image style setting are satisfied, and the users' experiences are significantly improved.

It should be noted that the method of the embodiment of the present disclosure can be executed by a single device, such as a computer or a server. The method of the embodiment of the present disclosure can also be applied to a distributed scenario, which is completed by the cooperation of multiple devices. In this distributed scenario, one of multiple devices can only perform one or more steps in the method of the embodiment of the present disclosure, and the multiple devices will interact with each other to complete the method.

It should be noted that the specific embodiments of the present disclosure have been described above. Other embodiments are within the scope of the appended claims. In some cases, the actions or steps recited in the claims can be performed in an order different from that in the above embodiments and still achieve the desired results. In addition, the processes depicted in the drawings do not necessarily require the specific order or the sequential order as shown to achieve the desired results. In some embodiments, multitasking and parallel processing are also possible or may be advantageous.

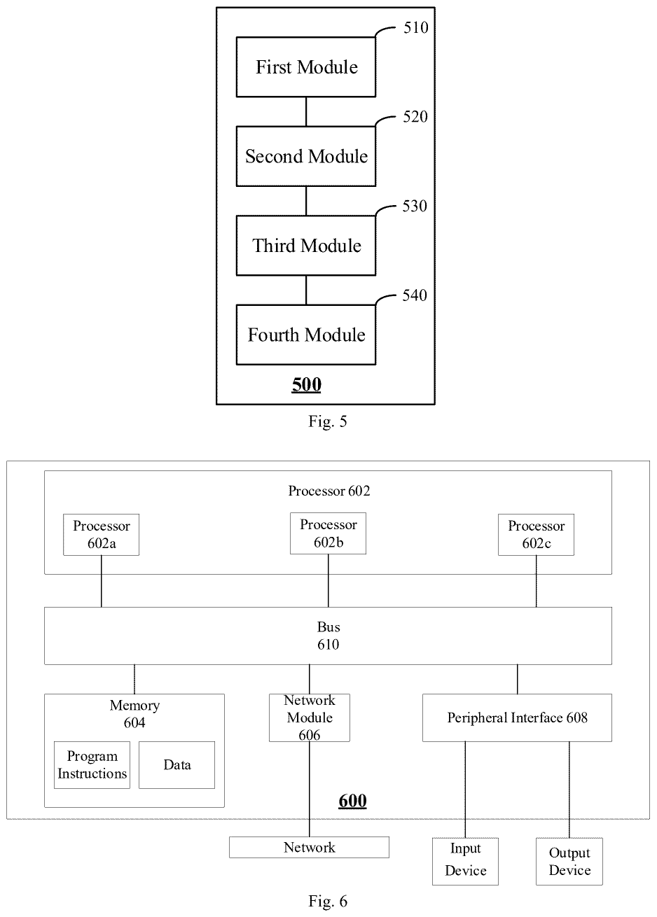

Based on the same technical concept, corresponding to the method of any of the above embodiments, the present disclosure further provides an image generation apparatus. FIG. 5 shows a schematic diagram of an exemplary apparatus 500 provided by an embodiment of the present disclosure. As shown in FIG. 5, the apparatus 500 can be used to implement the method 300, and can further include the following modules.

A first module 510, configured to acquire an initial text and an initial image; where the initial image includes at least one subject, and the at least one subject corresponds to at least one subject feature.

A second module 520, configured to generate a first intermediate image according to the initial text.

A third module 530, configured to perform feature extraction on the at least one subject feature, and perform subject redrawing at least once based on extracted information to generate a second intermediate image.

A fourth module 540, configured to fuse the first intermediate image and the second intermediate image to generate a target image.

In some exemplary embodiments, the second module 520 is further configured to:

determine feature information of the at least one subject feature; and

use the feature information as a restriction during generating the first intermediate image.

In some exemplary embodiments, the second module 520 is further configured to:

determine the feature information by using a feature-preserving plug-in, and embed the feature information into a model for generating the first intermediate image by using the feature-preserving plug-in.

In some exemplary embodiments, the third module 530 is further configured to:

perform subject recognition on the first intermediate image; and

perform image cropping based on a recognition result to generate a third intermediate image.

In some exemplary embodiments, the third module 530 is further configured to:

perform feature migration based on the third intermediate image according to the extracted information, and perform subject redrawing at a subject position in the third intermediate image according to the extracted information.

In some exemplary embodiments, the third module 530 is further configured to:

extract a posture feature from a subject posture by using a posture model, where the subject posture is controlled based on the posture feature during the feature migration.

In some exemplary embodiments, the third module 530 is further configured to:

determine texture information and light and shadow information of the first intermediate image; and

perform the subject redrawing on the at least one subject according to the texture information and the light and shadow information based on the extracted information.

In some exemplary embodiments, the third module 530 is further configured to:

perform resolution adjustment, local specific feature deformation adjustment and/or overall color feature uniformity adjustment on the redrawn subject feature, so as to perform local fine-tuning on the redrawn subject feature.

In some exemplary embodiments, the third module 530 is further configured to:

perform defect inspection and/or definition determination on the subject feature after the local fine-tuning;

perform defect adjustment on a defect position according to image information around the defect position, and/or perform definition adjustment according to a set definition, in response to a presence of defect in the subject feature after the local fine-tuning and/or in response to a requirement on definition adjustment, so as to perform the subject redrawing at least once, again.

In some exemplary embodiments, the third module 530 is further configured to:

perform feature extraction on the at least one subject feature and perform the subject redrawing at least once, by using a feature extraction model.

For the convenience of description, when describing the above apparatus, the functions are divided into various modules and described separately. Of course, the functions of various modules can be realized in one or more pieces of software and/or hardware when the present disclosure is implemented.

The apparatus of the above embodiment is used to realize the corresponding method 300 in any of the above embodiments, and has the beneficial effects of the embodiments of the corresponding method 300, which is not described in detail here.

Based on the same technical concept, corresponding to the method of any of the above embodiments, the embodiment of the present disclosure further provides a computer device for implementing the above method 300. FIG. 6 shows a schematic diagram of the hardware structure of an exemplary computer device 600 provided by an embodiment of the present disclosure. The computer device 600 can be used to implement the terminal device 102 of FIG. 1. In some scenarios, the computer device 600 can also be used to implement the server 104 and the database server 106 of FIG. 1.

As shown in FIG. 6, the computer device 600 may include a processor 602, a memory 604, a network module 606, a peripheral interface 608 and a bus 610. Among them, the processor 602, the memory 604, the network module 606 and the peripheral interface 608 communicate with each other inside the computer device 600 through the bus 610.

The processor 602 may be a Central Processing Unit (CPU), an image processor, a neural network processor (NPU), a microcontroller (MCU), a programmable logic device, a digital signal processor (DSP), an application specific integrated circuit (ASIC), or one or more integrated circuits. The processor 602 may be used to perform functions related to the techniques described in the present disclosure. In some embodiments, the processor 602 may also include multiple processors integrated into a single logical component. For example, as shown in FIG. 6, the processor 602 may include a plurality of processors 602a, 602b and 602c.

The memory 604 may be configured to store data (e.g., instructions, computer code, etc.). As shown in FIG. 6, the data stored in the memory 604 may include program instructions (for example, program instructions for implementing the method 300 of the embodiment of the present disclosure) and data to be processed (for example, the memory may store configuration files of other modules, etc.). The processor 602 can also access the program instructions and data stored in the memory 604 and execute the program instructions to operate on the data to be processed. The memory 604 may include volatile storage or nonvolatile storage. In some embodiments, the memory 604 may include random-access memory (RAM), read-only memory (ROM), optical disk, magnetic disk, hard disk, solid state hard disk (SSD), flash memory, memory stick, etc.

The network interface 606 may be configured to provide communication with other external devices to the computer device 600 via a network. The network can be any wired or wireless network capable of transmitting and receiving data. For example, the network may be a wired network, a local wireless network (e.g., Bluetooth, Wi-Fi, Near Field Communication (NFC), etc.), a cellular network, the Internet, or a combination thereof. It can be understood that the types of networks are not limited to the above specific examples.

The peripheral interface 608 may be configured to connect the computer device 600 with one or more peripheral devices for information input and output. For example, peripheral devices can include keyboard, mouse, touchpad, touch screen, microphone, various sensors and other input devices, as well as displayer, speaker, vibrator, indicator light and other output devices.

The bus 610 may be configured to transfer information among various components of the computer device 600 (for example, the processor 602, the memory 604, the network interface 606, and the peripheral interface 608), such as an internal bus (for example, a processor-memory bus), an external bus (a USB port, a PCI-E bus), and the like.

It should be noted that although the above architecture of the computer device 600 only shows the processor 602, the memory 604, the network interface 606, the peripheral interface 608 and the bus 610, in the specific implementation process, the architecture of the computer device 600 may also include other components necessary for normal operation. In addition, it can be understood by those skilled in the art that the architecture of the above-mentioned computer device 600 may also include only the components necessary to realize the technical solutions of the embodiments of the present disclosure, and it is not necessary to include all the components shown in the figure.

Based on the same technical concept, corresponding to the method of any of the above embodiments, the present disclosure further provides a non-transient computer-readable storage medium, which stores computer instructions causing the computer to execute the method 300 of any of the above embodiments.

The computer-readable medium of this embodiment includes permanent and non-permanent, removable and non-removable media, and information storage can be realized by any method or technology. Information can be computer-readable instructions, data structures, modules of programs or other data. Examples of storage medium for computers include, but not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technologies, compact disc read-only memory (CD-ROM), digital versatile disc (DVD) or other optical storage, magnetic tape cartridges, magnetic tape disk storage or other magnetic storage devices, or any other non-transmission medium that can be accessed by computing devices.

The computer instructions stored in the storage medium of the above embodiment are used to cause the computer to execute the method 300 as described in any embodiment, and have the beneficial effects of the corresponding method embodiment, which will not be described in detail here.

Based on the same technical concept, corresponding to the method 300 described in any of the above embodiments, the present disclosure further provides a computer program product, including computer program instructions, which, when run on a computer, cause the computer to execute the method 300 described in any of the above embodiments. In some embodiments, the computer program instructions may be executed by one or more processors of a computer to cause the computer and/or the one or more processors to perform the method 300. Corresponding to the execution body corresponding to various steps in various embodiments of the method 300, the processor executing the corresponding steps may belong to the corresponding execution body.

The computer program product of the above embodiment is used to cause the computer and/or the processor to execute the method 300 as described in any embodiment, and has the beneficial effects of the corresponding method embodiment, which will not be described in detail here.

It should be understood by those skilled in the art that the discussion of any of the above embodiments is only exemplary, and it is not intended to imply that the scope of the present disclosure (including the claims) is limited to these examples. Under the idea of the present disclosure, the technical features in the above embodiments or different embodiments can also be combined, and the steps can be realized in any order, and there are many other variations in different aspects of the embodiments of the present disclosure as described above, which are not provided in the details for the sake of brevity.

In addition, in order to simplify the explanation and discussion, and not to obscure the embodiments of the present disclosure, well-known power/grounding connections with integrated circuit (IC) chips and other components may or may not be shown in the provided drawings. In addition, devices/apparatuses may be shown in the form of block diagrams in order to avoid making the embodiments of the present disclosure difficult to understand, and this also takes into account the fact that details about the implementations of these devices/apparatuses shown in the form of block diagrams are highly dependent on the platform where the embodiments of the present disclosure will be implemented (i.e., these details should be completely within the understanding range of those skilled in the art). In the case where specific details (e.g., circuits) are set forth to describe exemplary embodiments of the present disclosure, it is obvious to those skilled in the art that the embodiments of the present disclosure can be practiced without these specific details or with changes in these specific details. Therefore, these descriptions should be regarded as illustrative rather than restrictive.

Although the present disclosure has been described in connection with specific embodiments thereof, many alternatives, modifications and variations of these embodiments will be obvious to those skilled in the art from the foregoing description. For example, other memory architectures (e.g., dynamic RAM(DRAM)) may use the discussed embodiments.

The embodiments of the present disclosure are intended to cover all such alternatives, modifications and variations that fall within the broad scope of the append claims. Therefore, any omission, modification, equivalent substitution, improvement, etc. made within the spirit and principles of the embodiments of the present disclosure should be included in the scope of protection of the present disclosure.

1. An image generation method, comprising:
acquiring an initial text and an initial image, wherein the initial image comprises at least one subject, and the at least one subject corresponds to at least one subject feature;
generating a first intermediate image according to the initial text;
performing feature extraction on the at least one subject feature, and performing subject redrawing at least once based on extracted information, to generate a second intermediate image; and
fusing the first intermediate image and the second intermediate image to generate a resulted image.

2. The method according to claim 1, wherein the generating a first intermediate image according to the initial text comprises:
determining feature information of the at least one subject feature; and
using the feature information as a restriction during generating the first intermediate image.

3. The method according to claim 2, wherein the determining feature information of the at least one subject feature comprises:
determining the feature information by using a feature-preserving plug-in, and embedding the feature information into a model for generating the first intermediate image by using the feature-preserving plug-in.

4. The method according to claim 2, wherein before the performing subject redrawing at least once based on extracted information, the method further comprises:
performing subject recognition on the first intermediate image; and
performing image cropping based on a recognition result to generate a third intermediate image.

5. The method according to claim 4, wherein the performing subject redrawing at least once based on extracted information comprises:
performing feature migration according to the extracted information based on the third intermediate image, and performing the subject redrawing at a subject position in the third intermediate image according to the extracted information.

6. The method according to claim 5, wherein the performing feature migration according to the extracted
information comprises:
extracting a posture feature from a subject posture by using a posture model, wherein the subject posture is controlled based on the posture feature during performing the feature migration.

7. The method according to claim 1, wherein the performing subject redrawing at least once based on extracted information comprises:
determining texture information and light and shadow information of the first intermediate image; and
performing the subject redrawing on the at least one subject according to the texture information and the light and shadow information based on the extracted information.

8. The method according to claim 7, wherein after the performing the subject redrawing on the at least one subject, the method further comprises:
performing at least one of resolution adjustment, local specific feature deformation adjustment and overall color feature uniformity adjustment on redrawn subject feature, so as to perform local fine-tuning on the redrawn subject feature.

9. The method according to claim 8, wherein the performing subject redrawing at least once based on extracted information comprises:
performing defect inspection and/or definition determination on the subject feature after the local fine-tuning; and
performing defect adjustment on a defect position according to image information around the defect position, and/or performing definition adjustment according to a set definition, in response to a presence of a defect in the subject feature after the local fine-tuning and/or in response to a requirement on definition adjustment, so as to perform the subject redrawing at least once, again.

10. The method according to claim 5, wherein the performing feature extraction on the at least one subject feature, and performing subject redrawing at least once based on extracted information comprise:
performing feature extraction on the at least one subject feature and performing the subject redrawing at least once, by using a feature extraction model.

11. A computer device, comprising a memory and at least one processor, wherein
the memory is configured to store a computer program executable on the at least one processor, and
the at least one processor is configured to execute the computer program so as to implement an image generation method, comprising:
acquiring an initial text and an initial image, wherein the initial image comprises at least one subject, and the at least one subject corresponds to at least one subject feature;
generating a first intermediate image according to the initial text;
performing feature extraction on the at least one subject feature, and performing subject redrawing at least once based on extracted information, to generate a second intermediate image; and
fusing the first intermediate image and the second intermediate image to generate a resulted image.

12. The computer device according to claim 11, wherein the generating a first intermediate image according to the initial text comprises:
determining feature information of the at least one subject feature; and
using the feature information as a restriction during generating the first intermediate image.

13. The computer device according to claim 12, wherein the determining feature information of the at least one subject feature comprises:
determining the feature information by using a feature-preserving plug-in, and embedding the feature information into a model for generating the first intermediate image by using the feature-preserving plug-in.

14. The computer device according to claim 12, wherein before the performing subject redrawing at least once based on extracted information, the method further comprises:
performing subject recognition on the first intermediate image; and
performing image cropping based on a recognition result to generate a third intermediate image.

15. The computer device according to claim 14, wherein the performing subject redrawing at least once based on extracted information comprises:
performing feature migration according to the extracted information based on the third intermediate image, and performing the subject redrawing at a subject position in the third intermediate image according to the extracted information.

16. The computer device according to claim 15, wherein the performing feature migration according to the extracted information comprises:
extracting a posture feature from a subject posture by using a posture model, wherein the subject posture is controlled based on the posture feature during the feature migration.

17. The computer device according to claim 11, wherein the performing subject redrawing at least once based on extracted information comprises:
determining texture information and light and shadow information of the first intermediate image; and
performing the subject redrawing on the at least one subject according to the texture information and the light and shadow information based on the extracted information.

18. The computer device according to claim 17, wherein after the performing the subject redrawing on the at least one subject, the method further comprises:
performing at least one of resolution adjustment, local specific feature deformation adjustment and overall color feature uniformity adjustment on redrawn subject feature, so as to perform local fine-tuning on the redrawn subject feature.

19. The computer device according to claim 18, wherein the performing subject redrawing at least once based on extracted information comprises:
performing defect inspection and/or definition determination on the subject feature after the local fine-tuning; and
performing defect adjustment on a defect position according to image information around the defect position, and/or performing definition adjustment according to a set definition, in response to a presence of a defect in the subject feature after the local fine-tuning and/or in response to a requirement on definition adjustment, so as to perform the subject redrawing at least once, again.

20. A non-transient computer-readable storage medium comprising computer instructions stored therein, wherein the computer instructions are configured to cause a computer to implement an image generation method, comprising:
acquiring an initial text and an initial image, wherein the initial image comprises at least one subject, and the at least one subject corresponds to at least one subject feature;
generating a first intermediate image according to the initial text;
performing feature extraction on the at least one subject feature, and performing subject redrawing at least once based on extracted information, to generate a second intermediate image; and
fusing the first intermediate image and the second intermediate image to generate a resulted image.
